(19) United States
(12) Patent Application Publication
(10) Pub. No.: US 2024/0384486 A1
(43) Pub. Date: Nov. 21, 2024

(54) Portable and Controllable Snow-Melting Devices and Systems

(71) Applicant: Youssef Ashraf Abdelhalim, Harrisburg, PA (US)

(72) Inventor: Youssef Ashraf Abdelhalim, Harrisburg, PA (US)

(21) Appl. No.: 18/198,779

(22) Filed: May 17, 2023

(51) Int. Cl. E01H 10/00; C09K 3/18; G05B 19/4155; H05B 1/02

(52) U.S. Cl. CPC E01H 10/007; C09K 3/185; G05B 19/4155; H05B 1/0244; G05B 2219/50333

(57) ABSTRACT

Snow melting devices in accordance with embodiments of the invention are disclosed. In one embodiment, a snow-melting device for melting snow and defrosting ice, may consist of a wireless transceiver module, a precipitation sensor configured to capture precipitation data from an environment, a first temperature sensor configured to capture environment temperature data, a container configured to hold melting water, where the container contains a water boiler, a release valve, and a second temperature sensor configured to capture melting water temperature data, and a processor. The processor may be operatively connected to the wireless transceiver module, the precipitation sensor, the temperature sensor, and the container, and execute a program stored in memory cause the snow-melting device to transmit a release signal to the valve when the precipitation data is above a precipitation threshold and the environmental temperature data is below the environmental temperature threshold.

### FIELD OF THE INVENTION

The present invention generally relates to snow removal and more specifically to portable and controllable snow-melting devices and systems.

### BACKGROUND

Snow includes individual ice crystals that grow while suspended in the atmosphere (e.g., within clouds). Snow may then fall and accumulate on the ground or any object on the ground. For example, snow may fall on houses, areas surrounding houses, roads, tarmacs, etc. Typically, snow may undergo various changes (e.g., consisting of frozen crystalline water) throughout its life cycle. For example, it may be ice crystals when forming in the atmosphere, increase to millimeter size, precipitate and accumulate on surfaces, then metamorphose in place, and ultimately melt, slide or sublimate away. However, depending on where the snow falls, it may be inconvenient and even hazardous if left to melt on its own.

### SUMMARY OF THE INVENTION

The various embodiments of the present portable and controllable snow-melting devices and systems (may be referred here as “snow-melting devices”) contain several features, no single one of which is solely responsible for their desirable attributes. Without limiting the scope of the present embodiments, their more prominent features will now be discussed below. In particular, the present snow-melting devices will be discussed in the context of melting a variety of winter weather precipitation across a larger, home-adjacent area. However, the use of the particular snow-melting devices is merely exemplary and various other snow-melting devices and systems may be utilized for melting winter weather precipitation as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that in current melting systems other than the present embodiments, the melting duty cycles are not customizable, and the entire melting system is static. For example, a previous embodiment may set a specific duty cycle and only be configured to distribute melting water in a specific area. The present embodiments solve this problem by allowing the user to customize the duty cycle of the release of the melting water, as well as allow the user to utilize different containers and make the winter weather melting system portable. The present embodiments thus advantageously enable the ability to control the controller unit via a wireless transceiver and allow for a variety of containers. The present embodiments provide these advantages and enhancements, as described below.

In a first aspect, a In a first aspect, a snow-melting device for melting snow and defrosting ice is provided, the snow-melting device comprising: a wireless transceiver module; a precipitation sensor configured to capture precipitation data from an environment; a first temperature sensor configured to capture environment temperature data; a container configured to hold melting water comprising a melting reagent and water, the container comprising a water boiler, a release valve, and a second temperature sensor configured to capture melting water temperature data; a processing module comprising: a processor operatively connected to the wireless transceiver module, the precipitation sensor, the temperature sensor, and the container; a memory storing a program comprising instructions that, when executed by the processor, cause the snow-melting device to: compare the precipitation data to a precipitation threshold value; compare the environmental temperature data to an environmental temperature threshold value; and when the precipitation data is above a precipitation threshold and the environmental temperature data is below the environmental temperature threshold, then transmit a release signal to the container, wherein the release signal configures the release valve to open thereby causing the melting water to flow out of the container.

In an embodiment of the first aspect, the program further comprises instructions that, when executed by the processor, further causes the snow-melting device to transmit a close signal to the container when a duty cycle high period is complete, wherein the close signal configures the release valve to close thereby stopping the melting water from flowing out of the container.

In another embodiment of the first aspect, the duty cycle high period is 10 minutes over a course of an hour.

In another embodiment of the first aspect, the program further comprises instructions that, when executed by the processor, further causes the snow-melting device to transmit a close signal to the container when the precipitation data sensor indicates there is no precipitation, wherein the close signal configures the release valve to close thereby stopping the melting water from flowing out of the container.

In another embodiment of the first aspect, the program further comprises instructions that, when executed by the processor, further causes the snow-melting device to transmit a close signal to the container when the environment temperature data is above the environmental temperature threshold, wherein the close signal configures the release valve to close thereby stopping the melting water from flowing out of the container.

In another embodiment of the first aspect, the program further comprises instructions that, when executed by the processor, further causes the snow-melting device to compare the melting water temperature data to a minimum threshold value and a maximum threshold value.

In another embodiment of the first aspect, the program further comprises further comprises instructions that, when executed by the processor, further causes the snow-melting device to transmit an activation signal to the water boiler when the melting water temperature data is below the minimum threshold value, wherein the activation signal turns the water boiler on.

In another embodiment of the first aspect, the program further comprises further comprises instructions that, when executed by the processor, transmit a deactivation signal to the water boiler when the melting water temperature data is above the maximum threshold value, wherein the deactivation signal turns the water boiler off.

In another embodiment of the first aspect, the melting water is distributed through a network of PVC piping.

In another embodiment of the first aspect, the processing module is an Arduino Uno microcontroller.

In a second aspect, an Arduino Uno microcontroller connects with the water boiler through a voltage relay.

In an embodiment of the second aspect, the snow melting device is connected and controlled wirelessly by a mobile application.

In another embodiment of the second aspect, the melting reagent comprises alcohol, and chloride salts.

In another embodiment of the second aspect, the melting water ratio is 30 gallons of water to 1.5 gallons of alcohol to three ounces of sodium stearate.

In another embodiment of the second aspect, the temperature threshold value is zero degrees Celsius.

In another embodiment of the second aspect, the minimum water temperature threshold value is zero degrees Celsius.

In another embodiment of the second aspect, the maximum water temperature threshold value is twenty degrees Celsius.

In another embodiment of the second aspect, the snow-melting device of claim 1, wherein the container is a thirty-two gallon container.

### BRIEF DESCRIPTION OF THE DRAWINGS

The various embodiments of the present snow-melting devices now will be discussed in detail with an emphasis on highlighting the advantageous features. These embodiments depict the novel and non-obvious snow-melting devices shown in the accompanying drawings, which are for illustrative purposes only. These drawings include the following figures:

FIG. 1A is a system diagram illustrating a perspective view of a snow-melting device in accordance with an embodiment of the invention.

FIG. 1B is a system diagram illustrating a top view of the snow-melting device in accordance with an embodiment of the invention.

FIG. 1C is a system diagram illustrating a side view of the snow-melting device in accordance with an embodiment of the invention.

FIG. 2 is a diagram illustrating a side perspective view of a valve configured to release melting water for melting snow and/or defrosting ice in accordance with an embodiment of the invention.

FIG. 3 is a block diagram of a snow-melting device in accordance with an embodiment of the invention.

FIG. 4 is a flowchart illustrating a process for automatically opening a release valve in accordance with an embodiment of the invention.

FIG. 5 is a flowchart illustrating a process for automatically closing a release valve at the end of a duty cycle in accordance with an embodiment of the invention.

FIG. 6 is a flowchart illustrating a process for automatically closing a release valve when there is no precipitation in accordance with an embodiment of the invention.

FIG. 7 is a flowchart illustrating a process for automatically closing a release valve when the environmental temperature is too warm for snow's existence in accordance with an embodiment of the invention.

FIG. 8 is a flowchart illustrating a process for automatically turning on a water boiler in accordance with an embodiment of the invention.

FIG. 9 is a flowchart illustrating a process for automatically turning off a water boiler in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, snow-melting devices for melting snow and/or defrosting ice in accordance with embodiments of the invention are provided. In many embodiments, the snow-melting devices may include a microcontroller (may also be referred to as a “processing module”), a container containing melting water that may include a melting reagent, a heating device (e.g., a water boiler), and a valve for controlling the release of the melting water from the container, as further described below. In various embodiments, the snow-melting devices may also include temperature sensor(s) and precipitation sensor(s) which may communicate with the microcontroller. For example, snow-melting devices may include a precipitation sensor configured to capture precipitation data from an environment. In some embodiments, the precipitation sensor may be configured to determine whether it is raining in the environment that the snow-melting device is operating within, as further described below. Further, the snow-melting devices may also include a first temperature sensor configured to capture environment temperature data such as, but not limited to, the environments ambient temperature, as further described below. In many embodiments, the microcontroller may be configured to compare the precipitation data to a precipitation threshold, compare the environment temperature data to an environmental temperature threshold value, and transmit a release signal to the container where the release signal configures the vale to open and thereby cause melting water to flow out of the container, as further described below.

In some embodiments, the container may also include a heating device (e.g., a water boiler) and a second temperature sensor configured to capture the temperature of the melting water (may be referred to as the “melting water temperature data”) allowing control of the temperature of the melting water, as further described below. In several embodiments, the snow-melting devices may be connected to a distribution network that receives the melting water from the container and controls the dispersion of the melting water through a larger area. Snow-melting devices and distribution networks in accordance with embodiments of the invention are further discussed below.

### Snow-Melting Devices and Distribution Networks

Snow-melting devices may be connected to distribution networks for providing melting water to a larger area. In many embodiments, distributing melting water may be performed by dispersing the melting water from a heated container through a valve. As further described below, snow-melting devices may be controlled using a controller unit and include various sensors such as, but not limited to, precipitation and temperature sensors.

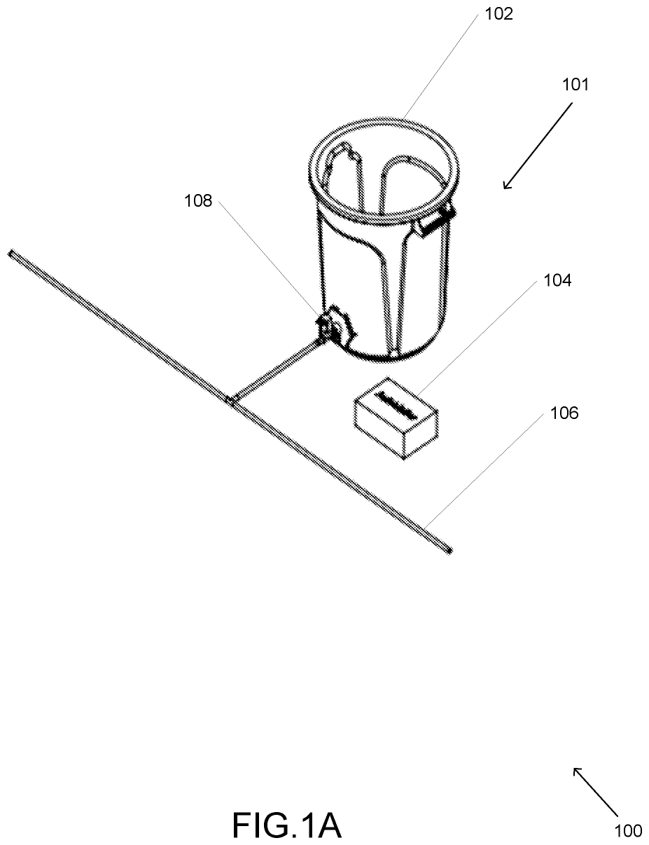

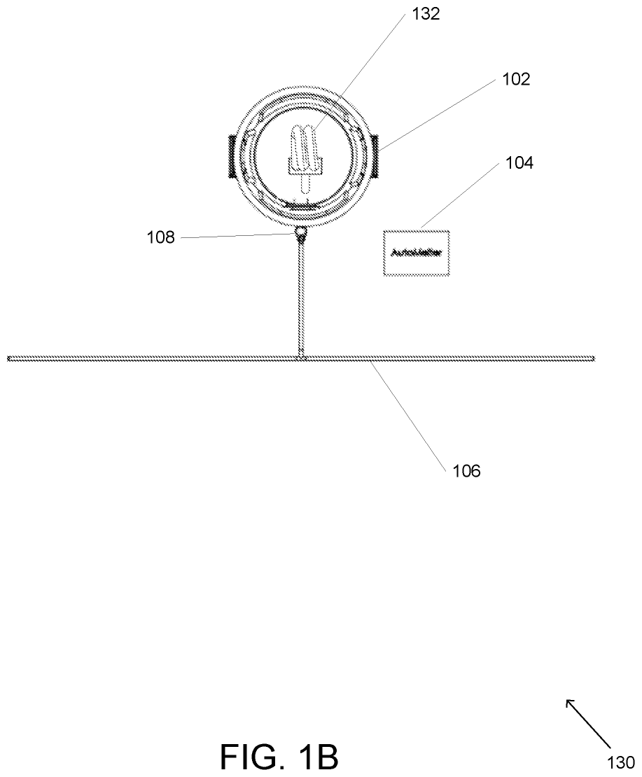

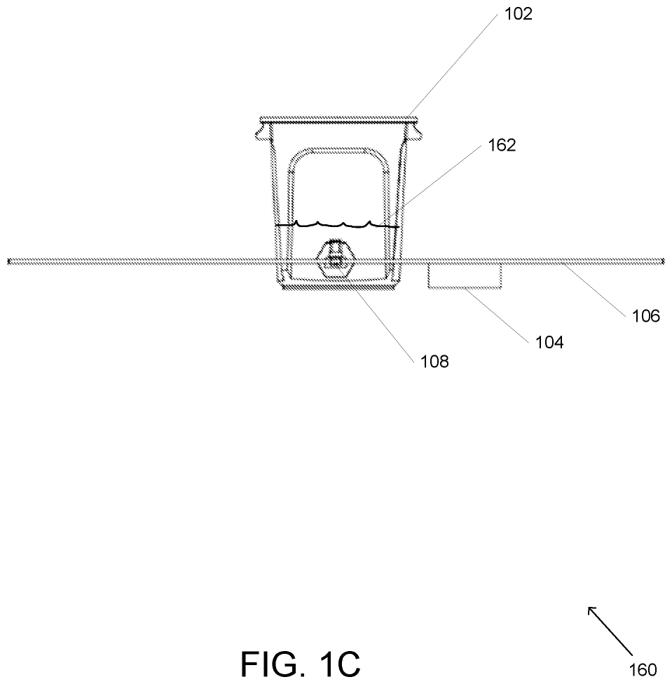

A system diagram illustrating a perspective view of a snow-melting device in accordance with an embodiment of the invention is shown in FIG. 1A. The distribution system 100 includes a snow-melting device 101 that may include one or more sensors, a container 102, and a controller unit 104, as further described below. In many embodiments, the container 102 may include a valve 108 configured to communicate with the controller unit 104 to release the melting water from the container, as further described below. In some embodiments, the valve 108 may also be powered by an external power source and be connected to the controller unit via wiring.

In reference to FIG. 1A, the snow-melting device 101 may be attached to a distribution network 106 through the valve 108. In some embodiments, the distribution network 106 may be made of piping including, but not limited to, PVC piping. In some embodiments, the piping may be laid out in a 2D grid. In some embodiments, the distribution network 106 may be placed on a user's driveway laid along the outline of the driveway.

A system diagram illustrating a top view 130 of the snow-melting device in accordance with an embodiment of the invention is shown in FIG. 1B. As described above, the snow-melting device may include a container 102 having a heater 132. In many embodiments, the heater 132 may be a metal coil which heats the melting water in the container 102 through contact with the melting water. In some embodiments, the heater 132 can be controlled through the controller unit 104. In some embodiments, the melting water may be heated between a minimum and maximum temperature threshold. For example, in some embodiments, the minimum temperature threshold is zero degrees Celsius. Further, in some embodiments, the maximum temperature threshold is twenty degrees Celsius. The controller unit 104 can be connected to the water boiler 132 via wiring known to one of ordinary skill in the art. In various embodiments, the container 102 may contain a temperature sensor (e.g., a second temperature sensor) to detect the temperature of the melting water, as described below. When the temperature of the melting water is below a minimum water temperature, the controller unit can turn on the water boiler. When the temperature of the water is equal to or above a maximum water temperature, the controller unit can turn off the water boiler.

A system diagram illustrating a side view 160 of the snow-melting device in accordance with an embodiment of the invention is shown in FIG. 1C. As described above, the snow-melting device may include a container 102 having melting water 162. In many embodiments of the invention, the melting water 162 may contain water and a melting reagent, which may be made of alcohols and salts. One example of a salt used is sodium stearate. However, other salts may be utilized including, but are not limited to, sodium chloride and potassium chloride. One example of an alcohol that may be utilized is ethanol. However, other alcohols may be utilized including, but are not limited to, isopropyl alcohol. In various embodiments, the melting water 162 may be a mixture that is proportioned to the requirements of a specific application. For example, in some embodiments, the melting water 162 may be proportioned through a ratio of 30 gallons of water to 1.5 gallons of alcohol to three ounces of sodium stearate.

Although specific snow-melting devices and distribution networks are discussed above with respect to FIGS. 1A-1C, any of a variety of snow-melting devices and distribution networks as appropriate to the requirements of a specific application can be utilized in accordance with embodiments of the invention. Valves for distributing melting water having melting reagent in accordance with embodiments of the invention are discussed further below.

### Valves for Distributing Melting Reagents

As described above, a valve may connect the snow-melting devices to distribution networks. In many embodiments, valves can be controlled by a controlling unit and powered via wiring to the controlling unit, as further described below.

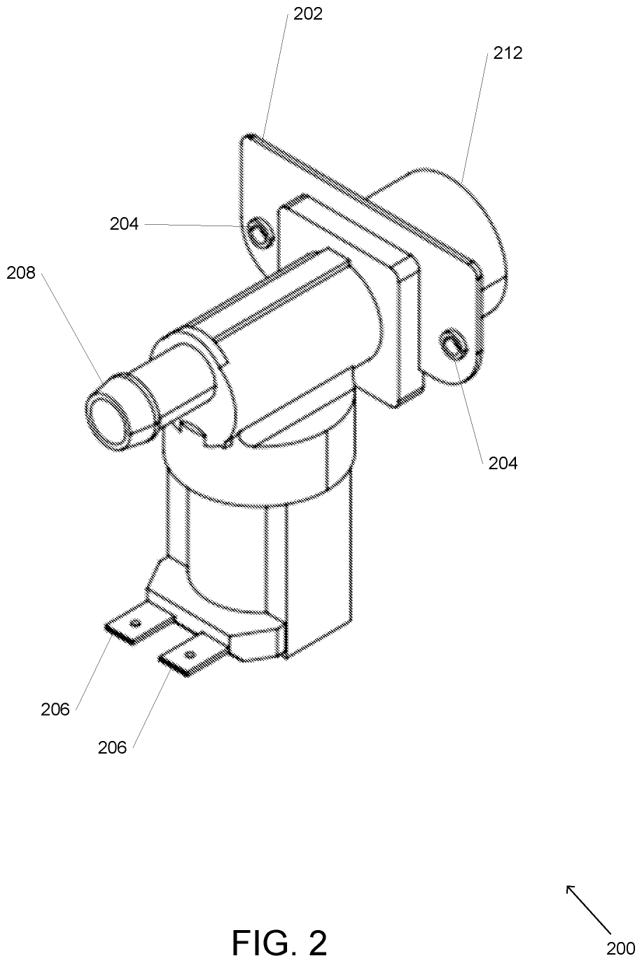

A diagram illustrating a side perspective view of a valve configured to release melting water for melting snow and/or defrosting ice in accordance with an embodiment of the invention is shown in FIG. 2. The valve 200 may include an opening 212 that accesses the container through a reinforcement face 202. The opening 212 allows for connection to the melting water. The valve 200 may be secured to the container through, but not exclusively, screws through screw holes 204, 206. In some embodiments, the valve 200 may be connected to the controlling unit of snow-melting devices through terminals 208 via wiring. In addition, the valve 200 may include a nozzle 210 that allow melting water to exit and disperse. For example, when the valve 200 is open, melt water from the container may flow through the opening 212 and out the nozzle 210, as further described below. In addition, when the valve 200 is closed, melt water in the container may be stopped from flowing out of the valve 200, as further described below.

Although a specific valve for controlling the flow of melting water from a container is discussed above with respect to FIG. 2, any of a variety of valves as appropriate to the requirements of a specific application can be utilized in accordance with embodiments of the invention. Snow-melting devices with device controllers in accordance with embodiments of the invention are discussed further below.

Snow-Melting Devices with Device Controllers

In many embodiments, distributing melting water and melting reagent may include dispersing liquid from a heated container through a valve of a snow-melting device. As further described below, snow-melting devices may be controlled using a controller unit and included various sensors such as, but not limited to, precipitation and temperature sensors.

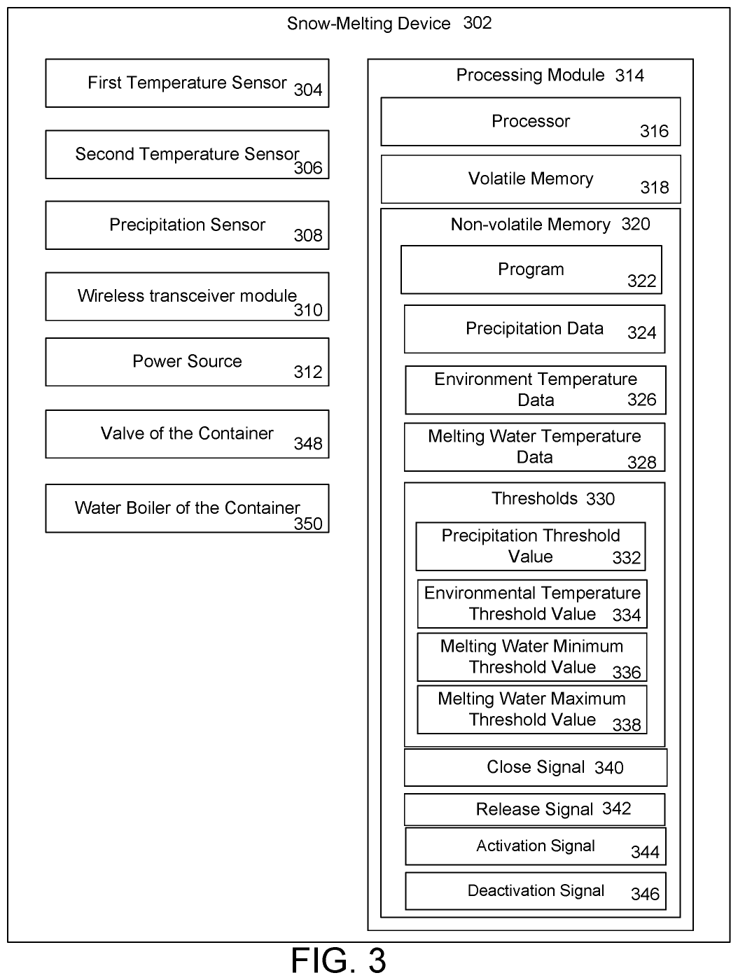

A block diagram of a snow-melting device 300 is shown in FIG. 3. The snow-melting device 300 may include a first temperature sensor 304, a second temperature sensor 306, a precipitation sensor 308, and a processing module 314 (may also be referred to herein as a “device controller”). In some embodiments, the snow-melting device 300 may include a power source 312 In some embodiments, the snow-melting device 300 may include a battery power source 312 and/or be configured to attach to an external power source such as, but not limited to, a power outlet. The processing module 314 may include a processor 316, a volatile memory 318 and a non-volatile memory 320. The non-volatile memory may store a program 322 that configures the snow-melting device 300 to collect precipitation data 324 using the precipitation sensor 308, collect environmental temperature data 326 using the first temperature sensor 304, and collect melting water temperature data 328 using the second temperature sensor 306. In many embodiments, the snow-melting device 300 may store the precipitation data 324, environmental temperature data 326, and the melting water temperature data 328 in the non-volatile memory 320. In addition, the non-volatile memory 320 may also store thresholds 330, such as, but not limited to, a precipitation threshold 332, an environmental temperature threshold 334, melting water temperature minimum threshold 336, and a melting water temperature maximum threshold 338.

In reference to FIG. 3, the snow-melting device 300 may be configured to send a close signal 340 and a release signal 342 to the valve for opening and closing the valve, respectively, as further described below. For example, the program 322 may configure the processor 316 to collect environmental temperature data 326 using the first temperature sensor 304. Further, the program 322 may configure the processor 316 to compare the environment temperature data 326 to the environmental temperature threshold value 334, as further described below. In addition, the program 322 may configure the processor 316 to collect precipitation data 324 using the precipitation sensor 308. Further, the program 322 may configure the processor 316 to compare the precipitation data 324 to the precipitation threshold value 332, as further described below.

In further reference to FIG. 3, if the precipitation data 324 is equal to or above the precipitation threshold value 332 and the environmental temperature data 326 is below the environmental temperature threshold 334, the program 322 may configure the processor to send a release signal 342 to the valve of the container 348. If the precipitation data 324 or the environmental temperature data 326 is not equal to or above the precipitation threshold value 332 or the environmental temperature threshold value 334, respectively, then the program 322 may send a close signal 340 to the valve of the container 348. In many embodiments, the program 322 may also configure the processor 316 to collect melting water temperature data 328 using the second temperature sensor 306 and compares it to both the melting water minimum threshold value 336 and the melting water maximum threshold value 338. If the melting water temperature data 328 is below the melting water minimum threshold value 336, the program 322 may configure the processor 316 to send an activation signal 344 to turn on the water boiler of the container 350. If the melting water temperature data 328 is above or equal to the melting water maximum threshold value 338, the program 322 may configure the processor 316 to send a deactivation signal 344 to the water boiler of the container 350. In addition, the program may also configure the processor 316 to allow for communication using a wireless transceiver module 310, as further described below.

Although specific snow-melting devices with device controllers are discussed above with respect to FIG. 3, any of a variety of snow-melting device including various device controllers as appropriate to the requirements of a specific application can be utilized in accordance with embodiments of the invention. Processes for snow-melting devices in accordance with embodiments of the invention are discussed further below.

### Processes for Snow-Melting Devices

In various embodiments, snow-melting devices may be automatically or manually controlled. For example, users may use a mobile application to either rely on automatic control of the release valve and water boiler to distribute melting water or manually control the release valve and water boiler. One advantage of utilizing sensors and a microcontroller is that it allows the snow melting device to autonomously melt snow without manual intervention.

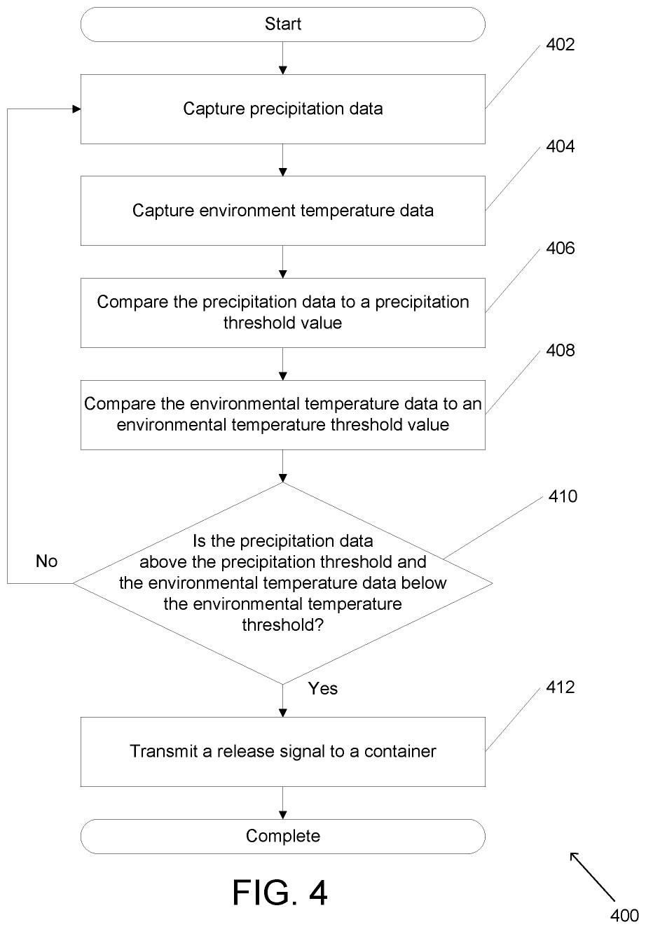

A process for automatically opening a release valve in accordance with an embodiment of the invention is illustrated in FIG. 4. The process 400 includes capturing (402) precipitation data to determine whether precipitation is falling from the sky. In many embodiments, the precipitation sensor returns a value of 0 to indicate the absence of precipitation and 1 to indicate the existence of precipitation. The process also includes capturing (404) environmental temperature data to determine whether environmental conditions are cold enough to produce snow. In many embodiments, the precipitation data and the environmental temperature data, when analyzed together, can be used to detect the presence of snowfall. The process further includes comparing (406) the precipitation data to a precipitation threshold value and comparing (408) the environmental temperature data to an environmental temperature threshold value. In several embodiments, the precipitation data threshold value can be 0, while the environmental temperature threshold value should be 0 degrees Celsius. Specifically, the process may determine (410) whether the precipitation data is above the precipitation data threshold value and whether the environmental temperature data is below the environmental temperature threshold value. If both conditions are satisfied, a release signal is transmitted (412) to a container, allowing a melting water to flow out.

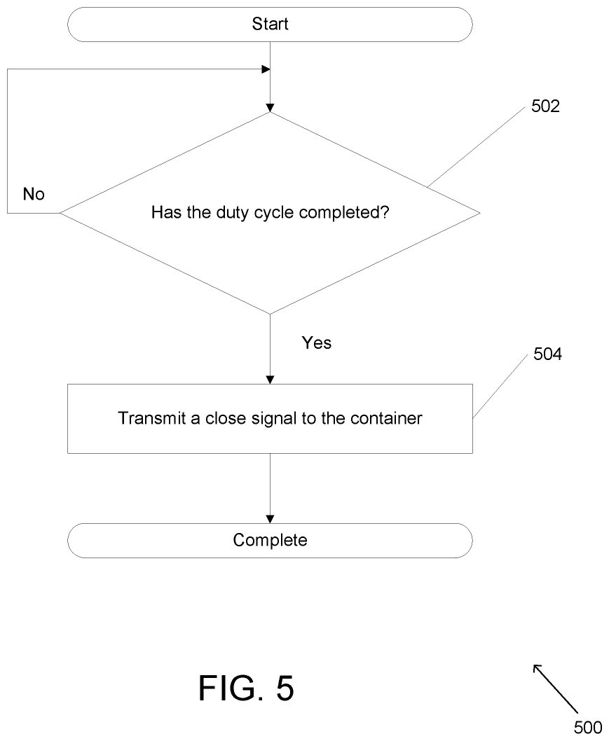

The process for automatically opening a release valve is counterbalanced by various processes that automatically close a release valve when certain conditions have been satisfied. A process for automatically closing a release valve at the end of a duty cycle in accordance with an embodiment of the invention is illustrated in FIG. 5. The process 500 may include determining (502) whether the duty cycle has been completed. In many embodiments, a duty cycle constitutes the amount of time across one hour for which a device actively performs its duties. The parameters of a duty cycle can be set by a user. For example, in several embodiments, the device can have a duty cycle of 10 minutes per hour, meaning a release valve remains open for 10 minutes after a release signal is transmitted, and remains closed for the remaining 50 minutes of the hour. If the duty cycle has ended, a close signal is transmitted (504) to the container. If the duty cycle has not yet completed, the process again asks (502) whether the duty cycle has completed until it has been completed.

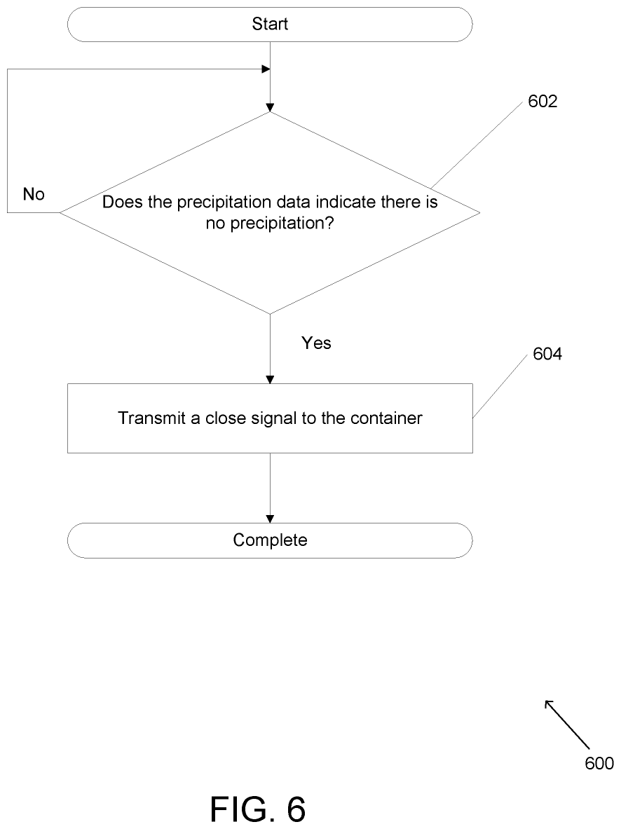

A process for automatically closing a release valve when there is no precipitation in accordance with an embodiment of the invention is illustrated in FIG. 6. The process may include determining (602) whether the precipitation data indicates there is no precipitation. In several embodiments, the precipitation data indicates there is no precipitation when a precipitation sensor returns a value of 0. If there is no precipitation, a close signal is transmitted (604) to the container. If there is precipitation, the process returns to the question (602) of whether there is precipitation until no precipitation is detected. In some embodiments, the automatic opening and closing of a release valve can be controlled manually by use of a mobile application.

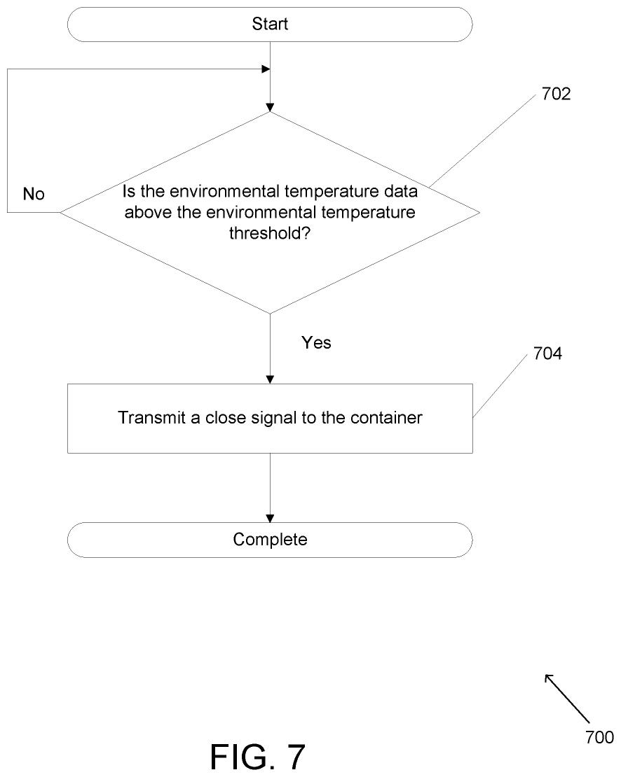

A process for automatically closing a release valve when the environmental temperature is too warm for snow's existence in accordance with an embodiment of the invention is illustrated in FIG. 7. The process 700 may include determining (702) whether the environmental temperature data is above the environmental temperature threshold. In many embodiments, the environmental temperature threshold is the freezing point of water, or 0 degrees Celsius. If the environmental temperature is above the environmental temperature threshold, snow on surfaces will melt naturally without needing a melting reagent, so a close signal is transmitted (704) to the container.

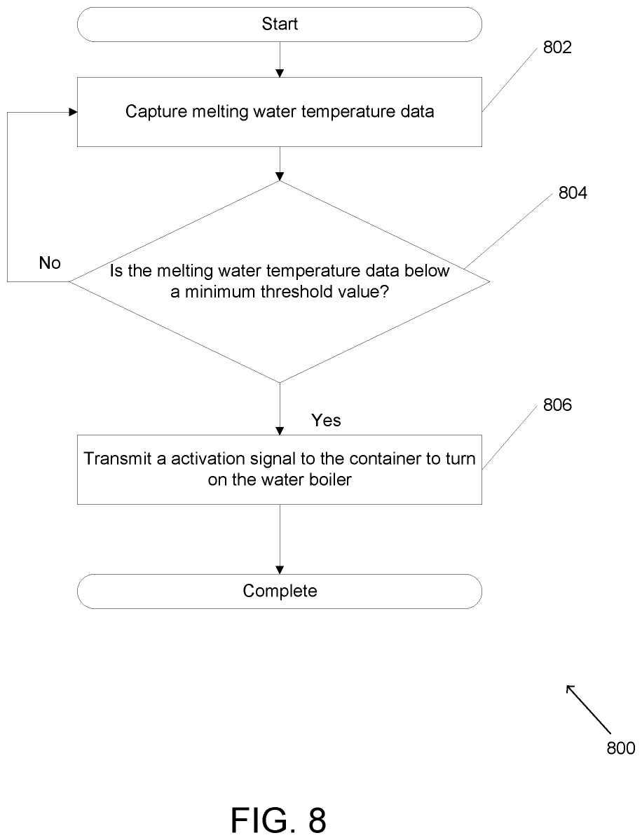

In addition to automatically modulating the release and close of a release valve, the device can also automatically modulate the powering on and powering down of a water boiler to form a completely autonomous system. Modulating a water boiler is essential for an automatic melting system, as the melting water itself may freeze over depending on how cold the environment is. A process for automatically turning on a water boiler in accordance with an embodiment of the invention is illustrated in FIG. 8. The process 800 first captures (802) the temperature of the melting water. The process then determines (804) whether the melting water temperature data is below a minimum threshold value. In many embodiments the melting water minimum threshold is zero degrees Celsius. If the melting water temperature data is below a minimum threshold value, an activation signal is transmitted (806) to the container to turn on the water boiler. Otherwise, the process repeatedly captures (802) melting water temperature data and compares (804) it to a minimum threshold value until the melting water temperature data reads below a minimum threshold value.

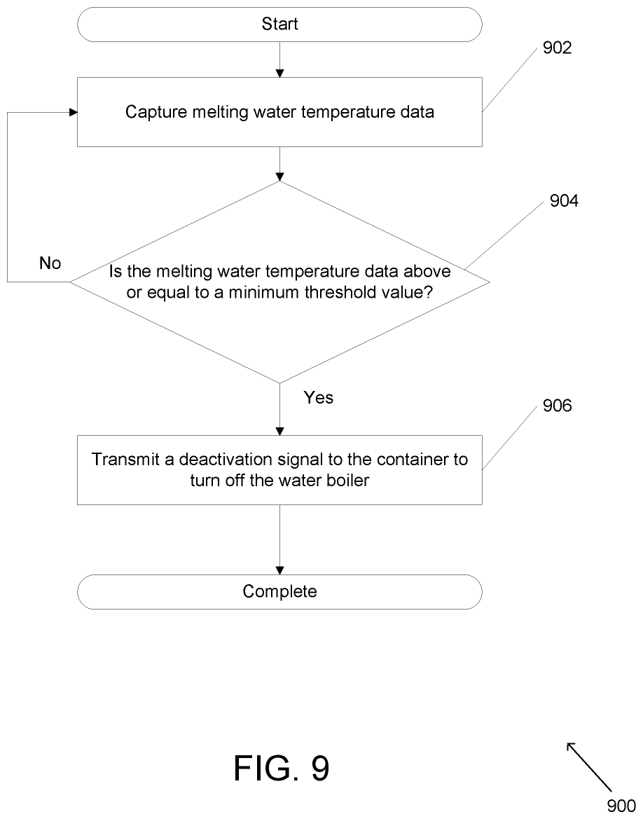

In the same way that the activation of a water boiler is moderated automatically, the deactivation of the water boiler is controlled automatically. A process for automatically turning off a water boiler in accordance with an embodiment of the invention is illustrated in FIG. 9. The process 900 first captures (902) the melting water temperature data. The process further includes determining (904) whether the melting water temperature is above or equal to a minimum threshold value. In several embodiments the melting water minimum threshold is zero degrees Celsius. If the melting water temperature is above or equal to a minimum threshold value, a deactivation signal is transmitted (906) to the container to turn off the water boiler. In most embodiments, a user can manually override the water boiler's automatic activation and deactivation by use of a mobile application. If the melting water temperature data is below the minimum threshold, the process continues to capture (902) melting water temperature data until it is above or equal to a minimum threshold value (904), upon which the deactivation signal is transmitted (906).

Although specific processes and hardware implementations for automatically controlling a release valve and water boiler are discussed above with respect to FIGS. 4-9, any of a variety of processes and hardware implementations as appropriate to the requirements of a specific application can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A snow-melting device for melting snow and defrosting ice, the snow-melting device comprising:
a wireless transceiver module;
a precipitation sensor configured to capture precipitation data from an environment;
a first temperature sensor configured to capture environment temperature data;
a container configured to hold melting water comprising a melting reagent and water, the container comprising a water boiler, a release valve, and a second temperature sensor configured to capture melting water temperature data;
a processing module comprising:
a processor operatively connected to the wireless transceiver module, the precipitation sensor, the temperature sensor, and the container;
a memory storing a program comprising instructions that, when executed by the processor, cause the snow-melting device to:
compare the precipitation data to a precipitation threshold value;
compare the environmental temperature data to an environmental temperature threshold value; and
when the precipitation data is above a precipitation threshold and the environmental temperature data is below the environmental temperature threshold, then transmit a release signal to the container, wherein the release signal configures the release valve to open thereby causing the melting water to flow out of the container.

2. The snow-melting device of claim 1, wherein the program further comprises instructions that, when executed by the processor, further causes the snow-melting device to transmit a close signal to the container when a duty cycle high period is complete, wherein the close signal configures the release valve to close thereby stopping the melting water from flowing out of the container

3. The snow-melting device of claim 2, wherein the duty cycle high period is 10 minutes over a course of an hour.

4. The snow-melting device of claim 1, wherein the program further comprises instructions that, when executed by the processor, further causes the snow-melting device to transmit a close signal to the container when the precipitation data sensor indicates there is no precipitation, wherein the close signal configures the release valve to close thereby stopping the melting water from flowing out of the container.

5. The snow-melting device of claim 1, wherein the program further comprises instructions that, when executed by the processor, further causes the snow-melting device to transmit a close signal to the container when the environment temperature data is above the environmental temperature threshold, wherein the close signal configures the release valve to close thereby stopping the melting water from flowing out of the container.

6. The snow-melting device of claim 1, wherein the program further comprises instructions that, when executed by the processor, further causes the snow-melting device to compare the melting water temperature data to a minimum threshold value and a maximum threshold value.

7. The snow-melting device of claim 1, wherein the program further comprises further comprises instructions that, when executed by the processor, further causes the snow-melting device to transmit an activation signal to the water boiler when the melting water temperature data is below the minimum threshold value, wherein the activation signal turns the water boiler on.

8. The snow-melting device of claim 7, wherein the program further comprises further comprises instructions that, when executed by the processor, transmit a deactivation signal to the water boiler when the melting water temperature data is above the maximum threshold value, wherein the deactivation signal turns the water boiler off.

9. The snow-melting device of claim 1, wherein the melting water is distributed through a network of PVC piping.

10. The snow-melting device of claim 1, wherein the processing module is an Arduino Uno microcontroller.

11. The snow-melting device of claim 10, wherein the Arduino Uno microcontroller connects with the water boiler through a voltage relay.

12. The snow-melting device of claim 1, wherein the snow melting device is connected and controlled wirelessly by a mobile application.

13. The snow-melting device of claim 1, wherein the melting reagent comprises alcohol, and chloride salts.

14. The snow-melting device of claim 13, wherein the melting water ratio is 30 gallons of water to 1.5 gallons of alcohol to three ounces of sodium stearate.

15. The snow-melting device of claim 1, wherein the temperature threshold value is zero degrees Celsius.

16. The snow-melting device of claim 1, wherein the minimum water temperature threshold value is zero degrees Celsius.

17. The snow-melting device of claim 1, wherein the maximum water temperature threshold value is twenty degrees Celsius.

18. The snow-melting device of claim 1, wherein the container is a thirty-two gallon container.
